(19) United States
(12) Patent Application Publication
(10) Pub. No.: US 2019/0102966 A1
(43) Pub. Date: Apr. 4, 2019

(54) METHODS AND SYSTEMS OF LIQUEFIED PETROLEUM GAS DISTRIBUTION

(71) Applicant: Envirofit International, Inc., Fort Collins, CO (US)

(72) Inventors: Nathan Lorenz, Laporte, CO (US); Ron Bills, Castle Rock, CO (US)

(73) Assignee: Envirofit International, Inc., Fort Collins, CO (US)

(21) Appl. No.: 16/087,255

(22) PCT Filed: Mar. 21, 2017
(86) PCT No.: PCT/US2017/023457

§ 371 Date: Sep. 21, 2018

Related U.S. Application Data
(60) Provisional application No. 62/311,178, filed on Mar. 21, 2016.

(51) Int. Cl. G07F 15/00; G07F 13/02; G06Q 50/06; G01N 29/02

(52) U.S. Cl. CPC G07F 15/001; G01N 29/02; G06Q 50/06; G07F 13/025

(57) ABSTRACT

A method of distributing liquefied petroleum gas is described. The method comprises receiving payment for a predetermined amount of liquefied petroleum gas, transmitting an instruction to a valve to distribute liquefied petroleum gas monitoring, by a metering device, an amount of liquefied petroleum gas distributed determining, by the metering device, that the amount of distributed liquefied petroleum gas has reached a threshold amount, wherein the threshold amount is based, at least in part, on the predetermined amount, and responsive to determining that the amount of distributed liquefied petroleum gas has reached the threshold amount, transmitting an instruction to the valve to cease distribution of the liquefied petroleum gas.

### BACKGROUND

Liquefied Petroleum Gas (LPG or liquid petroleum gas) provides clean and convenient energy to people. LPG systems are particularly useful in the developing world where infrastructure for power delivery is still improving. LPG systems typically include a tank in which LPG is stored. The tank may be connected to one or more appliances, such as stoves, and a valve opened to allow gas to flow from the LPG tank to the appliance. Many traditional LPG systems use a tank exchange program. A consumer rents or purchases a full tank from an LPG provider. The consumer then uses the LPG in the tank until the tank is empty and then the consumer can return and/or exchange the empty tank for a new, full tank. LPG is also used in the developed world, for example in rural environments where large LPG tanks may supply gas for many household uses. LPG may be used in a variety of contexts, such as heating and cooking, among others.

What is needed are devices, methods, and systems that aid in reducing fixed costs that may be associated with the use of LPG, and allow for consumers to purchase LPG fuel in smaller amounts. This may help to increase LPG use in developing countries, and provide for more predictable and economical use in developed countries.

### SUMMARY

According to one embodiment, a method of distributing liquefied petroleum gas is described. The method comprises receiving payment for a predetermined amount of liquefied petroleum gas, transmitting an instruction to a valve to distribute liquefied petroleum gas monitoring, by a metering device, an amount of liquefied petroleum gas distributed determining, by the metering device, that the amount of distributed liquefied petroleum gas has reached a threshold amount, wherein the threshold amount is based, at least in part, on the predetermined amount, and responsive to determining that the amount of distributed liquefied petroleum gas has reached the threshold amount, transmitting an instruction to the valve to cease distribution of the liquefied petroleum gas.

According to another embodiment, a system is described. The system comprises a tank configured to store a volume of liquefied petroleum gas, a metering device, wherein the metering device measures an amount of liquefied petroleum gas used by a consumer, and a valve, wherein the valve is configured to control flow of the liquefied petroleum gas from the tank and to close responsive to the metering device measuring that a predetermined amount of liquefied petroleum gas has been provided from the tank. The system may further comprise a location monitoring sub-system, wherein the location of the tank and metering device may be monitored and recorded.

According to yet another embodiment, method is described. The method comprises receiving a payment for a predetermined amount of liquefied petroleum gas, opening a valve to open to provide the predetermined amount of liquefied petroleum gas, determining that an amount of distributed liquefied petroleum gas has reached the predetermined amount, and closing the valve.

### BRIEF DESCRIPTION OF THE DRAWINGS

FIG. 1 is a schematic diagram of an LPG distribution system, in accordance with an embodiment of the present invention.

FIG. 2 is a perspective view of an LPG distribution system including a discrete volume tank, in accordance with an embodiment of the present invention.

FIG. 3 is a graph illustrating pressure/temperature curves for various LPG compositions, in accordance with an embodiment of the present invention.

FIG. 4 is a side elevation view of the metering device of FIG. 2, in accordance with an embodiment of the present invention.

FIG. 5 is a cross-sectional view of the metering device 106 of FIG. 2, in accordance with an embodiment of the present invention.

FIGS. 6A-D are perspective views of LPG distribution systems with discrete volume tanks, in accordance with an embodiment of the present invention.

FIG. 7 is a flowchart illustrating a method of LPG distribution, in accordance with an embodiment of the present invention.

### DETAILED DESCRIPTION

Embodiments disclosed herein recognize several drawbacks from traditional LPG distribution system. First, there are limited distribution points for LPG tanks. Many consumers must travel many miles to find a distribution point at which they can exchange an empty tank for a full one. Second, there is a high upfront cost. Purchasing larger tanks reduces the cost per kilogram of LPG, but larger tanks are more expensive upfront. Therefore, while many consumers can afford to use LPG on a daily basis, the high upfront costs of the tank may prevent the consumers from entering the market to begin with. Third, many traditional LPG tanks do not provide accurate indications of when the LPG in the tank may run out. As a result, some consumers are reluctant to use LPG for fear that the gas will run out in the middle of cooking a meal or before the consumer can afford to refill the tank. Fourth, because LPG is typically purchased by the tank, customers do not want to return a tank that still contains LPG. However, it is often difficult to know exactly how much LPG is left in a tank and to properly align LPG needs with the expiration of the LPG in the tank. Embodiments disclosed herein provide methods and systems for pay-as-you-go LPG use that may address one or more of the above identified limitations of previous systems.

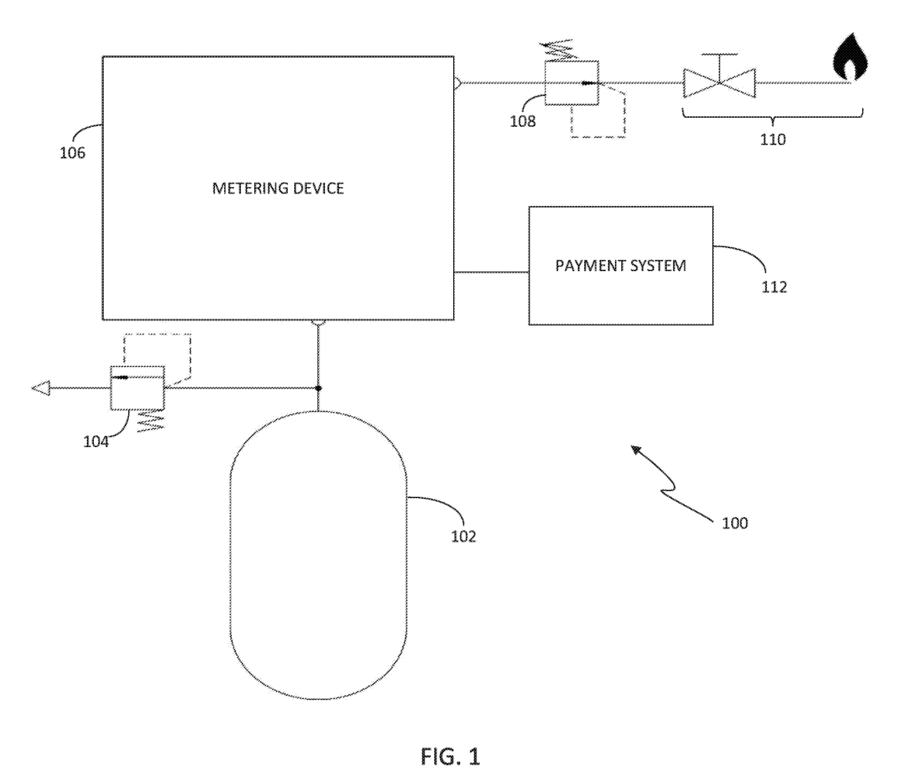

FIG. 1 is a schematic diagram of an LPG distribution system, generally designated 100, in accordance with an embodiment of the present invention. The system 100 includes a main LPG tank 102, a pressure release valve 104, a metering device 106, an appliance regulator 108, an appliance 110, and a payment system 112. Not shown is an optional location monitoring device.

The main LPG tank 102 is the primary reservoir for LPG in the system 100. The main LPG tank may generally be made of any suitable material for holding LPG, such as stainless steel or carbon steel. The main LPG tank 102 may be a permanently installed LPG tank or an exchangeable tank that can be removed and exchanged for a new tank. In some embodiments, the main LPG tank may be maintained by an LPG distribution company that may distribute, service, and otherwise maintain the LPG tank and system. In other embodiments, the main LPG tank may be maintained by a consumer. For example, the consumer may obtain a full, tamper-proof main LPG tank 102 from a distributor with a security deposit, bring the main LPG tank 102 to their home and connect the main LPG tank 102 to the system 100. In most of these embodiments, the LPG tank has a smart valve and/or other metering devices (discussed below) fixedly attached to the tank. LPG may be used from the main LPG tank 102 on a pay-as-you-go basis. In the pay-as-you-go system, the customer makes a payment for a predetermined amount of LPG, which is then distributed from the main LPG tank 102.

The pressure release valve 104 may generally be any type of pressure release valve. The pressure release valve 104 may be operable to relieve pressure in the system 100.

The metering device 106 measures the rate at which LPG is used from the main LPG tank 102 and closes a valve once the purchased amount of LPG has been used. The metering device may generally be any type of metering device capable of monitoring the mass of LPG remaining in the main LPG tank 102 and/or monitoring the amount of LPG being used. The metering device 106 may be located in-line between the main LPG tank 102 and the appliance 110. In one embodiment, the metering device 106 estimates the gas volume in the main LPG tank 102 by taking a known volume of gas out of the main LPG tank 102 quickly and measuring the instantaneous drop in pressure. According to another embodiment, the metering device 106 may measure the mass of LPG in the main LPG tank 102 using capacitive liquid level measurement sensors. In yet another embodiment, the metering device 106 may measure the liquid level in the main LPG tank 102 using petroleum tank floats. In yet another embodiment, the metering device 106 may measure the volume of gas in the main LPG tank 102 using a Helmholtz resonator.

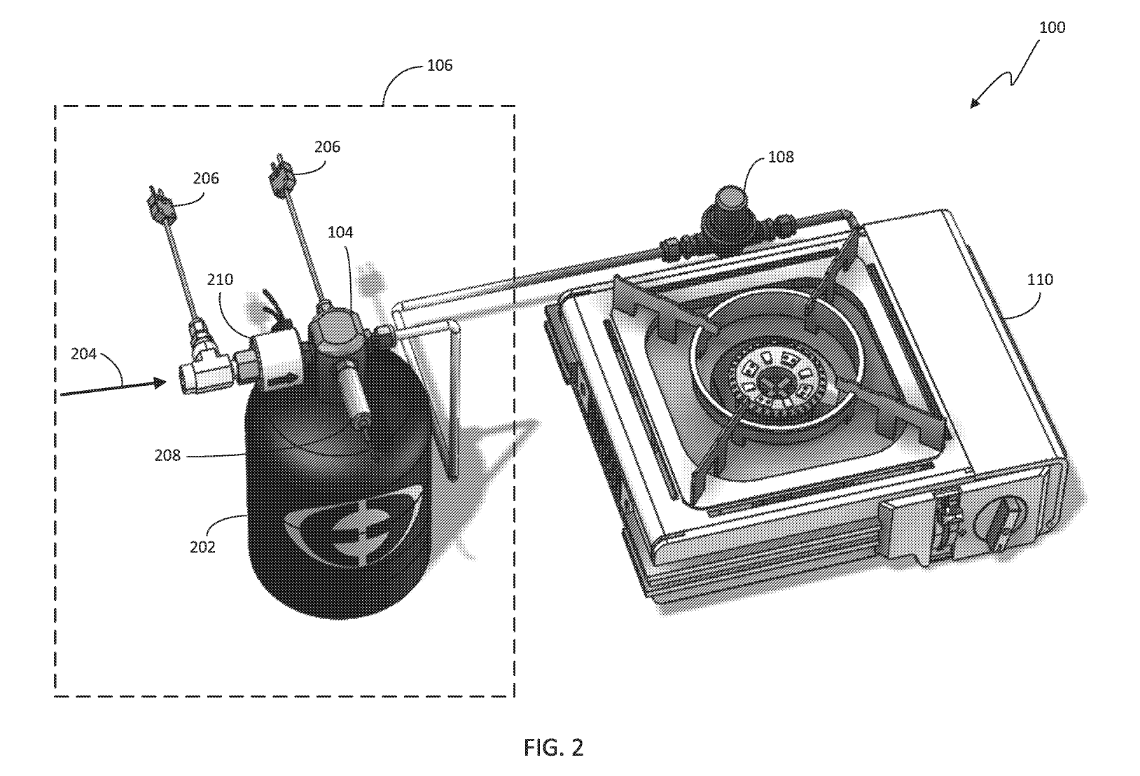

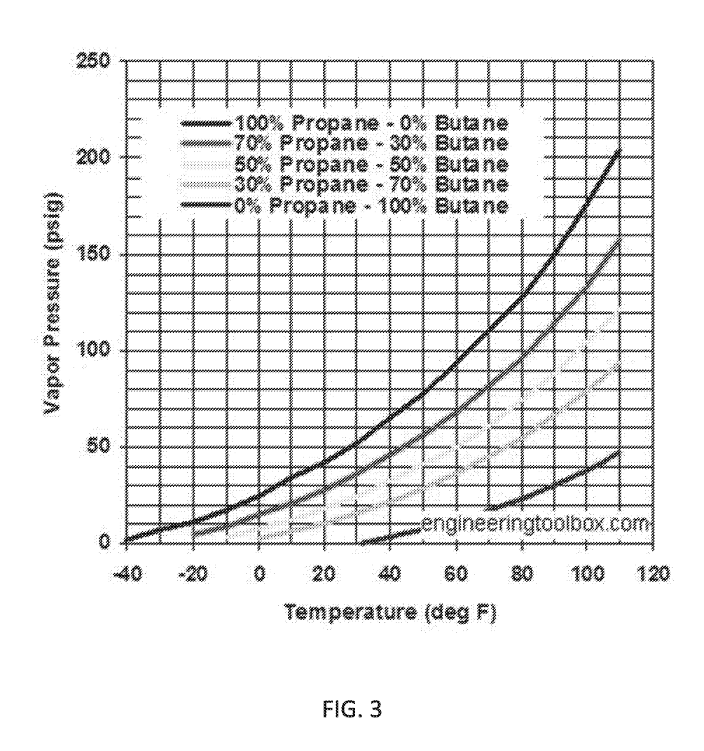

In yet another embodiment, the metering device 106 may use discrete volume metering to premeasure an amount of LPG from the main LPG tank 102. An embodiment implementing discrete volume metering is shown in FIG. 2. For example, a volume of liquefied or gaseous petroleum 202 may be allowed to flow into a discrete volume tank 202 through a smart valve 210. The smart valve 210 may be, for example, a solenoid valve that is configured to open and close responsive to instructions based on an amount of LPG that is purchased by a consumer. The smart valve 210 may be coupled to an electronic controller, which may have wireless connectivity capabilities (e.g., through Bluetooth, a SIM card, or other communication network). The controller may control the opening and closing of the valve based, in part, on instructions from a mobile device or a remote server. The temperature of the gas may be measured with temperature sensors 206 and the pressure may be measured with a pressure transducer 208. Based on the pressure and the temperature of the gas in the discrete volume tank 202, the composition and mass of the gas may be determined, for example by reference to a chart or look up table relating gas composition to vapor pressure and temperature, as shown in FIG. 3. Once the total mass in the discrete volume tank 202 reaches the capacity of the discrete volume tank or some other threshold amount, a smart valve 210, such as a solenoid valve, may disconnect the discrete volume tank 202 from the main LPG tank 102 and the consumer may use the gas from the discrete volume tank 202 to power the appliance 110. Once the amount of fuel in the discrete volume tank 202 drops to a threshold amount, additional LPG is transferred to the discrete volume tank 202 (in other embodiments, liquid petroleum is transferred to the discrete volume tank). The threshold may be based, for example, on a vapor pressure needed to maintain uninterrupted usage of the appliance 110. For example, an appliance 110 may use gas at vapor pressure of about 0.1 to 60 psi (an operating vapor pressure), while an LPG tank may have a pressure of about 100 to 200 psi, and the vapor pressure in the discrete volume tank may be between about 0.1 and 200 psi. Once the vapor pressure in the discrete volume tank 202 drops to a threshold amount at or above the operating vapor pressure, the discrete volume tank 202 may be refilled by activating the smart valve 210. The refilling of the discrete volume tank 202 may be monitored and each refill iteration may be counted. Based on the number of refills and the known volume of each usage or refill, the total amount of LPG may be monitored and when the amount used nears the amount purchased by the consumer, a prompt for an additional purchase may be provided to consumer. Discrete volume metering may be used in conjunction with or instead of various other types of metering.

In yet another embodiment, the metering device 106 may use ultrasonic metering to monitor the flow rate of LPG gas from the main LPG tank 102. An ultrasonic flow meter may determine the volumetric flow rate of LPG to the appliance 110. An ultrasonic flow meter determines the flow rate of the LPG by measuring the time of flight of a phonon through the gas both with the flow of the LPG and against the flow of the LPG. Based on the difference between the two times of flight, the distance between the transmitter and the receiver, and cross-sectional area of the meter, the volumetric flow rate of the LPG may be calculated. Ultrasonic metering may be used in conjunction with, or instead of other types of metering.

The payment system 112 may facilitate, receive, and/or confirm payment by a consumer for a specified amount of LPG. The payment system may be coupled to the metering device 106. In various embodiments, the payment system 112 may take a variety of forms. In one embodiment, the payment system 112 may be a computing system having one or more processors. The payment system 112 may be coupled to a communication network (not shown). The communication network may generally be any type of communication network. For example, the communication network may be a local area network or a wide area network (e.g., the Internet). The payment system 112 may be configured to communicate with one or more mobile devices over the network or other communication means (e.g., a short range communication means, such as Bluetooth®). For example, a consumer may provide payment information through a mobile phone connected to a cellular network or a Wi-Fi network. The mobile phone may communicate with the payment system 112 over the same or a different network and confirm that the consumer has paid. The payment system 112 may then communicate with the metering system 106 to provide a paid-for amount of LPG from the main LPG tank to the appliance 110.

In another embodiment, the payment system 112 may include an interface for direct interaction between a consumer and the payment system 112. For example, the payment system 112 may include a keypad for entering a credit card number or an authorization code that indicates the consumer has purchased a specified amount of LPG. In some embodiments, the keypad may be implemented as a backup and/or alternative system to the communication network discussed above. For example, in the event that the communication system becomes unavailable, the keypad may be used by the consumer to purchase additional LPG. In such an embodiment, a consumer may provide payment information through a mobile phone or other device coupled to a network, or a scratch-card purchased from a vendor. The payment information may be confirmed, for example, by a remote server or other third party. In response, the remote server may provide a validation code to the consumer through a text message, a webpage, a phone call, or other communication means. The consumer may then enter the validation code into the payment system 112 via the keypad. The payment system 112 may verify the validation code against a database of validation codes and in response to verifying the validation code, the payment system 112 may communicate with the metering device 106 to provide a paid-for amount of LPG from the main LPG tank to the appliance 110.

The appliance regulator 108 may measure and/or regulate a pressure of LPG provided to the appliance 110. The appliance regulator 108 may include, for example, a pressure transducer and be calibrated with the appliance 110. In various embodiments, the appliance regulator may communicate with the metering device 106 to ensure that the pressure of LPG provided to the appliance 110 does not drop below a threshold amount. For example, the appliance regulator 108 may determine that the LPG pressure provided by the discrete volume tank 202 has dropped below a threshold amount and, in response, trigger the smart valve 210 to refill the discrete volume tank 202 from the LPG main tank 102. In some embodiments, the appliance regulator 108 may be located before, after, or incorporated into the metering device 106. For example, in embodiments implemented with an ultrasonic metering device 106, the appliance regulator 108 may be located between the main LPG tank 102 and the metering device 106. Such a placement may improve the ability of the appliance regulator 108 to accurately regulate the flow of LPG to the appliance 110, as well as improving the ability of the metering device to measure gas flow.

The appliance 110 may generally be any type of machine or device that can be powered by LPG. For example, the appliance 110 may be a gas powered stovetop for use in cooking, a heater, a barbeque, a water heater, a refrigerator, a clothes dryer, an oven, or a combination thereof.

A location monitor may be any type of machine or device that may provide information on the location of the tank, metering device, smart valve, etc. In some embodiments, the location monitor may be a satellite navigation receiver, for example a GPS receiver. In other embodiments, the location monitor may include a radio-frequency transmitter unit that may send a signal to a receiving unit. In these embodiments, the receiving unit may be connected to a phone, cellular network, internet, or other network for sending information the distribution company. In some embodiments, the location monitor may provide the distribution company information on the location of the tank, metering device, valve, etc. In some embodiments, the location monitor may alert the consumer or the distribution company if the tank, metering device, valve, etc. has been re-located. In many embodiments, the location monitor may also issue an alert if the location monitor is separated from the tank, metering device, valve etc. The location device may aid in preventing the loss, transfer, or mis-use of the disclosed tank, metering device, etc.

The pay as you go option may remove the upfront cost barrier that consumers face. To implement the pay as you go model, the smart valve may accurately measure how much LPG is released from the tank. As it does this it can also monitor how much fuel is remaining in the tank. This information can be clearly displayed to the consumer allowing them to manage how much fuel they are using over time to meet their budget needs and also gives them a clear indication of when their tank is running low so they can plan ahead to have it refilled or exchanged without ever running out. Since consumers only pay for the fuel that they use out of the tank they also need not worry about returning the tank early with some LPG left in the tank as they are not charged for that fuel. An additional potential value to the consumer may include in home refilling or an exchange program. By monitoring fuel usage in a home either remotely via a SIM enabled system or by tracking how many codes a customer has input into the valve a central distribution management system would know when the tank is getting low and notify the consumer to set up a time to exchange or refill the tank. Doing this may improve consumer experience. In addition, this ability to monitor the volume of LPG in a tank, and notify the consumer and/or distribution company may be useful in both developing and developed countries.

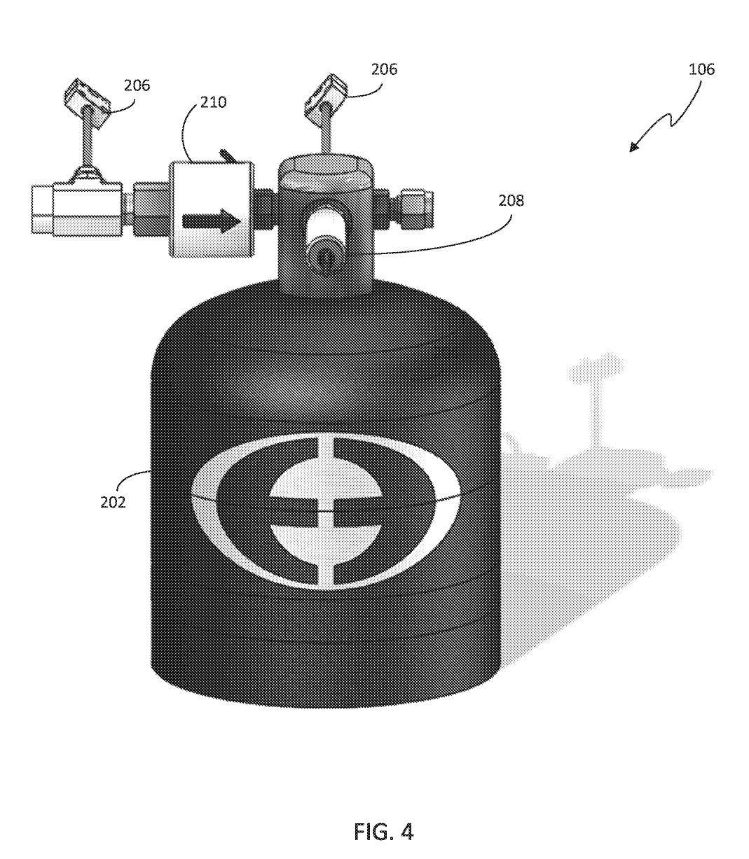

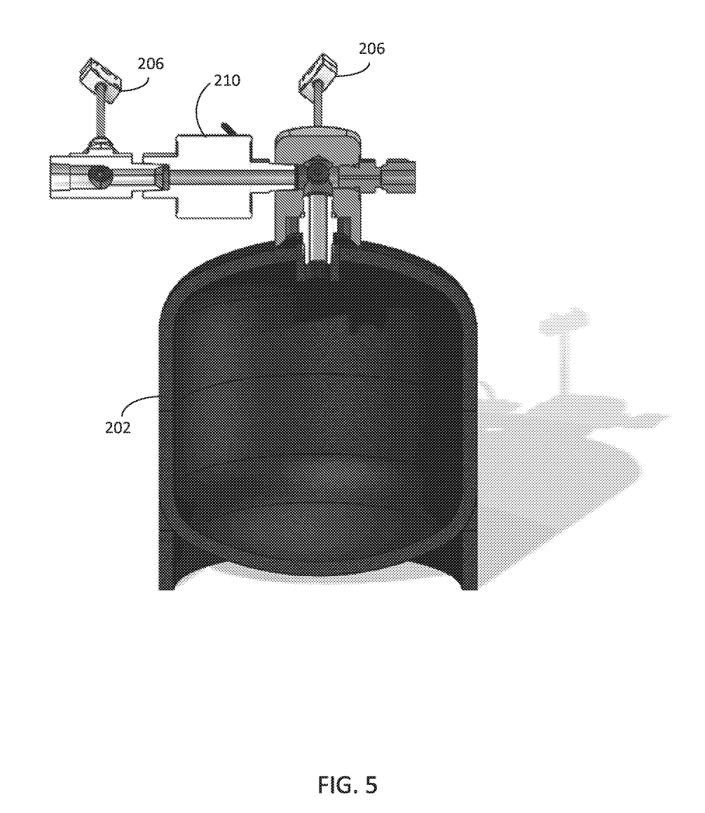

FIG. 4 is a side elevation view of the metering device 106 of FIG. 2. As described above, LPG may be allowed to flow through the valve 210 into the discrete volume tank 202. The temperature sensors 206 and the pressure transducer 208 measure the temperature and pressure, respectively of the LPG gas in order to determine the composition and mas of LPG in the discrete volume tank 202. Once the discrete volume tank 202 is filled, the valve 210 may be closed, and the consumer may use the LPG from the discrete volume tank 202 until it drops below a threshold amount, at which point the process repeats itself. The process may repeat until the total amount of LPG used by the consumer reaches the purchased amount (or near the purchased amount) at which point the consumer may be prompted to purchase more LPG. FIG. 5 is a cross-sectional view of the metering device 106 of FIG. 2.

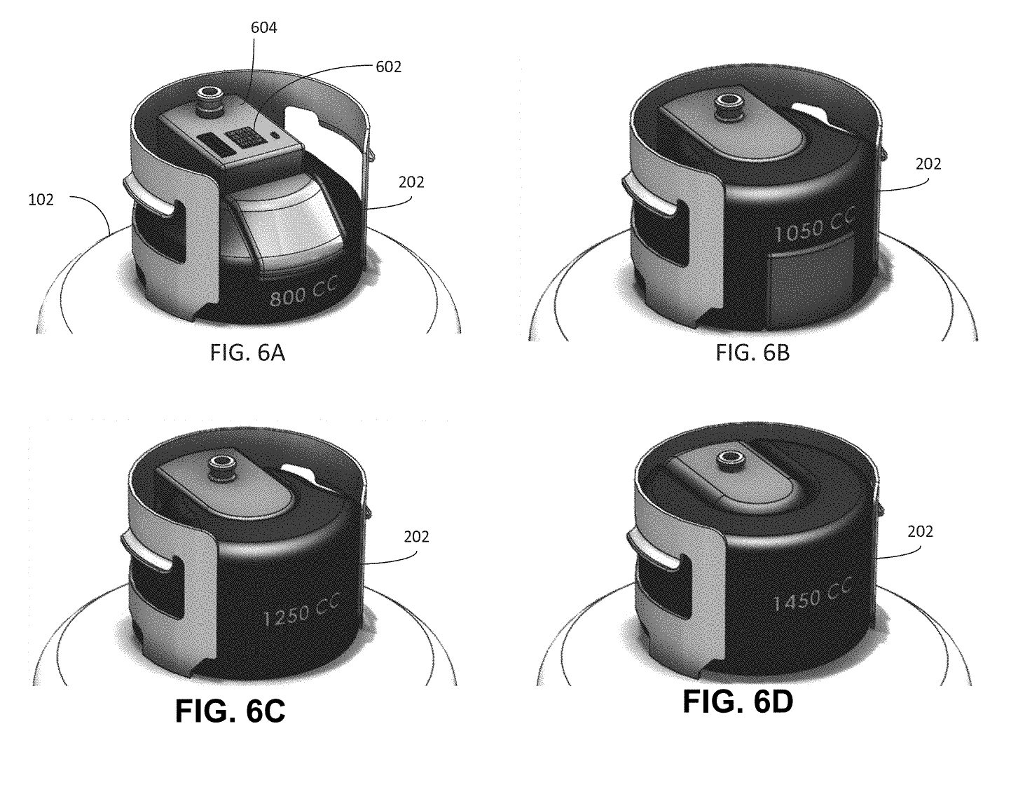

FIG. 6A is a perspective view of an LPG distribution system with a discrete volume tank, in accordance with an embodiment of the present invention. As shown in FIG. 6A, the discrete volume tank 202 may be adapted to fit integrally with the main LPG tank 102 and a housing 604. The housing 604 may include one or more components of the distribution system 106 and/or the payment system 112 of FIG. 1. For example, the housing 604 may contain one or more temperature sensors 206, the pressure transducer 208, and/or the valve 210. The housing 604 may further include a keypad 602 for use with the payment system 112, as described above with respect to FIG. 1. The discrete volume tank 202 may generally be configured to hold any volume of LPG. For example, in FIG. 6A an 800 cc discrete volume tank 602 is shown. In FIG. 6B, a 1,050 cc discrete volume tank 602 is shown, in FIG. 6C, a 1,250 cc discrete volume tank 602 is shown, and in FIG. 6D, a 1,450 cc discrete volume tank 602 is shown.

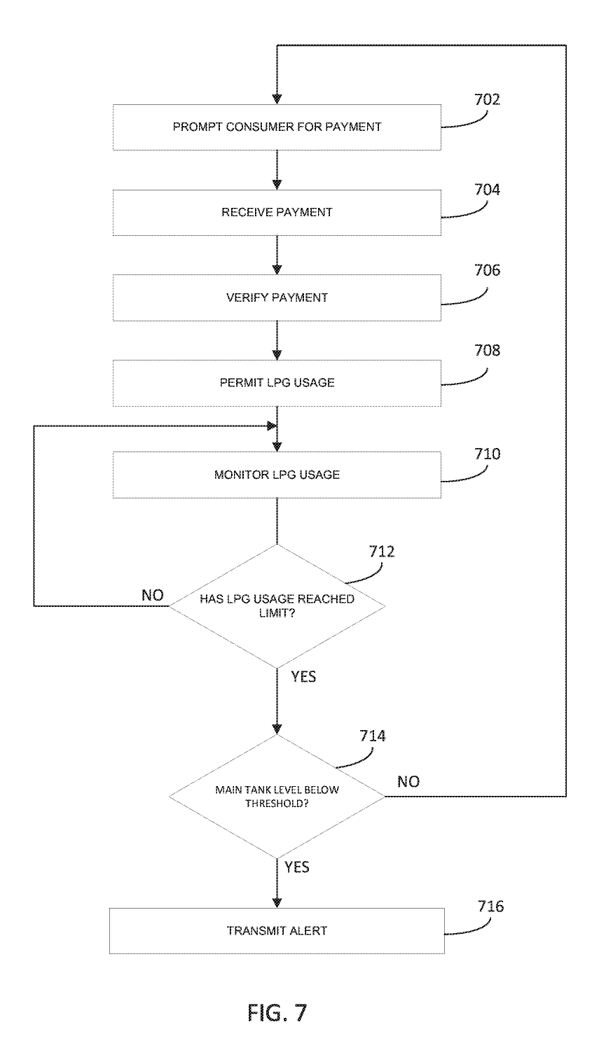

FIG. 7 is a flowchart illustrating a method of LPG distribution, in accordance with an embodiment of the present invention. In operation 702, the LPG distribution system 100 prompts a consumer for payment. In various embodiments, the prompt may be provided in one of a variety of ways. For example, the consumer may navigate to a webpage using a computer or smartphone, and the webpage may prompt the consumer to enter their payment information, such as a credit card number. In another embodiment, a consumer may dial in to a call center which then prompts them, through either a call center operator or through an automated payment system, to enter their payment information orally or through a telephone key pad. In yet another embodiment, a consumer may be prompted for payment through a mobile application. In still another embodiment, a consumer may be prompted for payment through an in person interaction, such as through a local retailer. In some embodiments, a consumer may purchase a scratch card from a vendor, wherein the scratch card includes a verification, activation, or payment code that is accessible after payment to the vendor. In many embodiments, scratch cards may be issued in various denominations, which may activate the system to dispense various amounts of petroleum gas.

In operation 704, the LPG distribution system 100 receives payment from a consumer. For example, the consumer may provide payment through the same medium through which the prompt for payment was provided in operation 702. Payment may be made in any manner, such as credit card, mobile application, wire transfer, electronic transfer of funds, check, cash payment, gift card, etc.

In operation 706, the LPG distribution system 100 verifies the payment. Payment verification may be conducted remotely or by the payment system 112. For example, a remote server may verify that the consumer has tendered payment for a specified amount of LPG by verifying a credit card number. Alternatively, verification may be conducted by the payment system itself. For example, in response to tendering payment, the consumer may be provided with a verification code. The verification code may be provided via text message, phone call, email, scratch card, or any other mode of communication. To verify that payment has been made, the consumer may manually enter the verification code into the payment system 112 via a key pad, such as the key pad 602 of FIG. 6A.

In operation 708, the LPG distribution system 100 permits LPG usage. The LPG distribution system may permit LPG usage by opening the smart valve 210 in response to the entry of a valid verification code may trigger the metering device 106 to open the smart valve 210 and to allow the purchased amount of LPG to flow into the discrete volume tank 202 and/or to the appliance 110. In some embodiments, the smart valve may remain open until the purchased amount of LPG is used by the consumer.

In embodiments where verification occurs remotely, a remote server may verify that payment has been received and provide an instruction to the metering device 106 of the LPG distribution system 100 to provide a specified amount of LPG for use by the appliance. For example, the remote server may communicate via a computer or cellular network with the LPG distribution system to provide a specific instruction regarding an amount of LPG purchased.

In operation 710, the LPG distribution system 100 monitors LPG usage. LPG usage may be monitored, for example, by the metering device 106, as described above with respect to claim 1. For example, the metering device 106 may monitor an amount of LPG stored in the discrete volume tank 202. Alternatively, the metering device 106 may use ultrasonic metering to measure the flow rate of the LPG to the appliance.

In decision block 712, the LPG distribution system 100 determines whether the LPG usage has reached its limit. In embodiments implemented with a discrete volume tank 202, the LPG distribution system 100 may monitor the amount of LPG in the discrete volume tank 202 and when the level of LPG in the tank reaches a certain threshold or is empty, the LPG distribution system 100 may determine that the LPG usage has reached its limit. Alternatively, in embodiments where the amount of LPG used is actively monitored, such as through ultrasonic flow monitoring, the metering device 106 may compare the measured amount of LPG used with the purchased amount to determine whether the LPG usage has reached its limit. If the LPG distribution system 100 determines that the LPG usage has not reached its limit (decision block 712, NO branch), then the LPG distribution system 100 returns to monitoring LPG usage in operation 710.

If the LPG distribution system 100 determines that the LPG usage has reached its limit (decision block 712, YES branch), then the LPG distribution system 100 determines whether a level of LPG in the main LPG tank 102 has dropped below a threshold amount. The threshold amount may be set by a tank distributor and may be indicative that the main LPG 102 may be nearly empty and should be exchanged or a full tank or refilled. If the LPG distribution system 100 determines that the level of LPG in the main LPG tank 102 has not dropped below a threshold amount (decision block 714, NO branch), then the LPG distribution system 100 may prompt the consumer for payment in operation 702.

If the LPG distribution system 100 determines that the level of LPG in the main LPG tank 102 has dropped below a threshold amount (decision block 714, YES branch), then the LPG distribution system 100 transmits an alert in operation 714. The alert may be a visual and/or auditory alert and may be displayed on the LPG distribution system 100 or transmitted to a distributer over a communication network. Alternatively or in addition, the alert may be provided via text message, email, phone call, or any other type of communication. The alert may communicate that the main LPG tank 102 may be nearly empty and may need to be refilled or exchanged in order to continue using LPG as a power source.

Various embodiments described herein are presented for illustrative purposes only and are not meant to be limiting. Various components, parts, operations, and/or method steps may be omitted or presented in a different configuration or order than those particular embodiments described above without deviating from the scope of the invention as set forth in the attached claims.

What is claimed is:

1. A method of distributing liquefied petroleum gas comprising:
receiving payment for a predetermined amount of liquefied petroleum gas;
transmitting an instruction to a valve to distribute liquefied petroleum gas;
monitoring, by a metering device, an amount of liquefied petroleum gas distributed;
determining, by the metering device, that the amount of distributed liquefied petroleum gas has reached a threshold amount, wherein the threshold amount is based, at least in part, on the predetermined amount; and
responsive to determining that the amount of distributed liquefied petroleum gas has reached the threshold amount, transmitting an instruction to the valve to cease distribution of the liquefied petroleum gas.

2. The method of claim 1, further comprising:
responsive to determining that the amount of distributed liquefied petroleum gas has reached the threshold amount, transmitting an alert to a consumer.

3. The method of claim 1, further comprising:
providing a prompt for payment for the predetermined amount of liquefied petroleum gas;

4. The method of claim 1, further comprising:
responsive to receiving the payment, providing a verification code;
receiving, through a user interface, the verification code; and
verifying the verification code.

5. The method of claim 4, wherein the verification code is received through a key pad that is operative coupled to the valve.

6. The method of claim 1, wherein monitoring the amount of liquefied petroleum gas comprises transmitting liquefied petroleum gas into a discrete volume tank having a known volume.

7. The method of claim 1, wherein monitoring the amount of liquefied petroleum gas comprises monitoring liquefied petroleum gas flow with an ultrasonic meter.

8. A system comprising:
a tank configured to store a volume of liquefied petroleum gas;
a metering device, wherein the metering device measures an amount of liquefied petroleum gas used by a consumer; and
a valve, wherein the valve is configured to control flow of the liquefied petroleum gas from the tank and to close responsive to the metering device measuring that a predetermined amount of liquefied petroleum gas has been provided from the tank.

9. The system of claim 8, further comprising:
a payment system configured to facilitate a payment by a consumer for the predetermined amount of liquefied petroleum gas.

10. The system of claim 9, wherein the payment system comprises a key pad for entering a verification code indicative that the predetermined amount of liquefied petroleum gas is paid for.

11. The system of claim 8, wherein the metering device comprises an ultrasonic flow meter.

12. The system of claim 8, wherein the metering device comprises a second tank configured to store a volume of liquefied petroleum gas that is less than the tank.

13. The system of claim 8, further comprising:
an appliance coupled to the tank, wherein the appliance is powered by liquefied petroleum gas.

14. The system of claim 13, wherein the metering device is in-line between the tank and the appliance.

15. The system of claim 8, wherein the metering device comprises at least one temperature sensor and at least one pressure transducer.

16. A method comprising:
receiving a payment for a predetermined amount of liquefied petroleum gas;
providing liquefied petroleum gas to an appliance;
metering an amount of liquefied petroleum gas provided to the appliance;
determining that an amount of distributed liquefied petroleum gas has reached the predetermined amount; and
ceasing to provide liquefied petroleum gas to the appliance.

17. The method of claim 16, wherein providing the liquefied petroleum gas comprises opening a valve coupled to an electronic controller.

18. The method of claim 17, wherein the electronic controller is configured to communicate over a communication network.

19. The method of claim 16, wherein providing the predetermined amount of liquefied petroleum gas comprises providing a first amount of liquefied petroleum gas from a main tank to a discrete volume tank, wherein the first amount of liquefied petroleum gas is less than the predetermined amount.

20. The method of claim 19, wherein providing the predetermined amount of liquefied petroleum gas further comprises:
iteratively refilling the discrete volume tank to the first amount of liquefied petroleum gas to the first amount until a total amount of liquefied petroleum gas used reaches the predetermined amount.

21. A method of distributing liquefied petroleum gas comprising:
attaching a valve to a liquefied petroleum gas tank comprising a predetermined amount of liquefied petroleum gas;
monitoring, by a metering device, an amount of liquefied petroleum gas leaving the tank;
determining, by the metering device, the amount of distributed liquefied petroleum gas remaining in the tank, wherein the amount remaining is based, at least in part, on the predetermined amount; and
transmitting, to a receiver, the amount of liquefied petroleum gas remaining in the tank.

22. The method of claim 21, wherein the receiver is a cell phone.

23. The method of any of claims 21-22, wherein the receiver is fixedly attached to a metering device.

24. The method any of claims 21-23, wherein the receiver is maintained by a LPG distribution service and prompts an alert to a consumer.

25. The method any of claims 21-24, wherein the alert may prompt replacement of the LPG tank.

26. The method of any of claims 21-25, wherein the metering device is a discrete volume monitoring device.

27. The method of any of claims 21-26, wherein the metering device is an ultrasonic metering device.

28. A system for monitoring the amount of LPG in a tank comprising:
a tank configured to store a volume of liquefied petroleum gas;
a metering device, wherein the metering device measures an amount of liquefied petroleum gas removed from the tank by a consumer; and
a valve, wherein the valve is configured to control flow of the liquefied petroleum gas from the tank and to close responsive to the metering device measuring that a predetermined amount of liquefied petroleum gas has been provided from the tank.

29. The system of claim 28, further comprising:
an alert system configured to facilitate transmitting to a consumer the amount of liquefied petroleum gas remaining in the tank.

30. The system of any of claims 28-29, wherein the alert system comprises an indicator located on a cell phone, on or near the thank, at a distribution company, or a combination thereof.

31. The system of any of claims 28-30, wherein the metering device comprises an ultrasonic flow meter.

32. The system of any of claims 28-31, wherein the metering device comprises a second tank configured to store a volume of liquefied petroleum gas that is less than the tank.

33. The system of any of claims 28-32, further comprising:
one or more appliances coupled to the tank, wherein the one or more appliances powered by liquefied petroleum gas.

34. The system of any of claims 28-33, wherein the metering device is in-line between the tank and the appliance.

35. The system of any of claims 28-34, wherein the metering device comprises at least one temperature sensor and at least one pressure transducer.

36. A method of monitoring the amount of gas in an LPG tank comprising:
connecting a tank of LPG containing a predetermined amount of liquefied petroleum gas to at least one appliance;
providing liquefied petroleum gas from the tank to the appliance;
metering an amount of liquefied petroleum gas provided to the appliance;
determining the amount of LPG remaining in the tank; and
storing a value or percentage of the amount in a memory device.

37. The method of claim 36, further comprising providing the value or percentage to an indicator.

38. The method of any of claims 36-37, wherein the value or percentage is communicated over a communication network to a consumer or distribution company.

39. The method of any of claims 36-38, further comprising sending an alert to a consumer or distribution company when the amount of liquefied petroleum gas remaining in the tank is equal to an alert amount.

40. The method of any of claims 36-39, wherein metering is by a metering device.
